(19) United States
(12) Patent Application Publication
(10) Pub. No.: US 2026/0245114 A1
(43) Pub. Date: Aug. 20, 2026

(54) MONITORING INTERACTION METRICS ACROSS COMPUTER PLATFORMS TO GENERATE USER INTERFACES FOR COMBINED MANAGEMENT OF LOCAL AND GLOBAL DIGITAL ASSETS

(71) Applicant: Chime Financial, Inc., San Francisco, CA (US)

(72) Inventors: Konstantin Getmanchuk, Brooklyn, NY (US); Alison Stapleton, New York, NY (US); Rob Law, Newton, PA (US); Jason Lee, New York, NY (US)

(21) Appl. No.: 19/054,073

(22) Filed: Feb. 14, 2025

(51) Int. Cl. G06Q 30/0226

(52) U.S. Cl. CPC G06Q 30/0226

(57) ABSTRACT

The present disclosure relates to methods, systems, and non-transitory computer-readable media for monitoring cross-platform computer interactions and extracting interaction metrics to generate user interfaces for combined management of local and global digital assets. Specifically, the disclosed systems can monitor third-party interaction metrics and/or global asset account interaction metrics based on client interactions with a third-party computer platform and/or a computer platform of an inter-network facilitation system. Based on monitoring such cross-platform interaction metrics, the disclosed systems can manage variations in global digital assets for a global asset account and generate and manage corresponding local digital assets for a local asset digital account associated with the client. In some instances, the disclosed systems provide, for display via a client device, indicators of the global asset account and the local asset digital account, including generated local digital assets determined from cross-platform interaction metrics.

### BRIEF DESCRIPTION OF THE DRAWINGS

The detailed description provides one or more embodiments with additional specificity and detail through the use of the accompanying drawings, as briefly described below.

FIG. 1 illustrates an overview of generating local digital assets for a local asset digital account based on monitoring third-party interaction metrics extracted from a third-party computer platform and global asset account interaction metrics extracted from client device interactions with an inter-network facilitation system in accordance with one or more embodiments.

FIG. 2 illustrates an example diagram of generating local digital assets based on monitoring a third-party computer platform to generate third-party interaction metrics in accordance with one or more embodiments.

FIG. 3 illustrates an example diagram of generating local digital assets based on monitoring client device interactions with an inter-network facilitation system to generate global asset account interaction metrics in accordance with one or more embodiments.

FIG. 4 illustrates generating local digital assets based on extracting various interaction metrics from different computer platforms over time in accordance with one or more embodiments.

FIG. 5 illustrates an example diagram of providing, for display via a user interface of a client device, an indicator of a global asset account and an indicator of a local asset digital account reflecting a local time-based digital asset and a local transfer-based digital asset in accordance with one or more embodiments.

FIG. 6 illustrates an example graphical user interface that provides a local digital asset redemption portal for redeeming generated local digital assets in accordance with one or more embodiments.

FIG. 7 illustrates a diagram of an environment in which a cross-platform asset generation system can operate in accordance with one or more embodiments.

FIG. 8 illustrates an example flowchart of a series of acts for monitoring cross-platform interactions metrics to generate local time-based digital assets and local transfer-based digital assets and provide global asset account indicators and local asset account indicators to client devices, in accordance with one or more embodiments.

FIG. 9 illustrates a block diagram of an exemplary computing device in accordance with one or more embodiments.

FIG. 10 illustrates an example environment for an inter-network facilitation system in accordance with one or more embodiments.

### DETAILED DESCRIPTION

This disclosure describes one or more embodiments of a cross-platform asset generation system that monitors cross-platform computer interactions and extracts interaction metrics to generate user interfaces for combined management of local and global digital assets. Specifically, in one or more embodiments, the cross-platform asset generation system utilizes one or more servers to monitor third-party computer platforms and generate third-party interaction metrics and monitor client device interactions with an inter-network facilitation system to generate global asset account interaction metrics. To elaborate, in some embodiments, the cross-platform asset generation system can generate third-party interaction metrics by monitoring a third-party computer platform to generate time interaction metrics, task interaction metrics, and/or one or more other third-party interaction metrics between a client corresponding to a client device and a third-party entity. Additionally, the cross-platform asset generation system can generate global asset account interaction metrics by monitoring interactions between a client device and computing devices of an intern-network facilitation system. For example, the cross-platform asset generation system can monitor client device interactions and extract global asset account interaction metrics based on initiation of an automatic, periodic global asset transfer sequence, initiation of a global asset account, and/or one or more other global asset account interaction metrics associated with the client corresponding to the client device.

The cross-platform asset generation system can generate local digital assets for a local asset digital account associated with the client based on monitoring and extracting third-party interaction metrics and global asset account interaction metrics. For example, the cross-platform asset generation system can monitor a third-party computer platform to detect a time duration during which the client performs a target task in relation to a third-party entity. In response to detecting this task-specific third-party interaction metric, the cross-platform asset generation system can generate a local time-based digital asset for the local asset digital account. As another example, the cross-platform asset generation system can monitor client device interactions with an inter-network facilitation system and detecting a global asset account interaction metric of initiating an automatic, periodic global asset transfer sequence. In response to detecting this global asset account interaction metric, the cross-platform asset generation system can generate a local transfer-based digital asset for the local asset digital account. Further, in some embodiments, the cross-platform asset generation system provides, for display via the client device, indicators of the global asset account and the local asset digital account, including local digital assets generated in response to the detected interaction metrics.

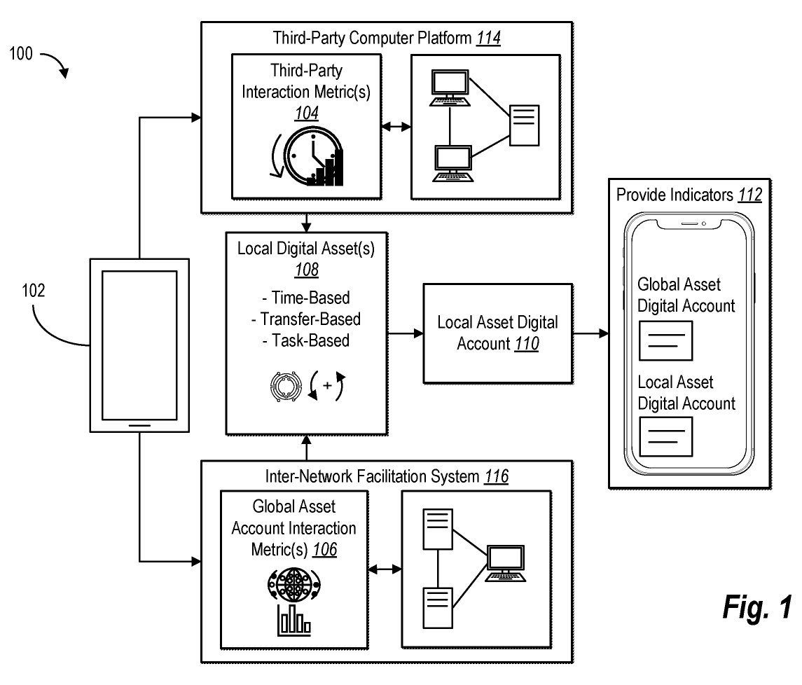

For example, FIG. 1 illustrates an overview of monitoring third-party interaction metrics and global asset account interactions metrics across computer platforms to generate user interfaces for combined management of local and global digital assets, in accordance with one or more embodiments. Additional detail regarding the various acts and processes introduced in relation to FIG. 1 is provided thereafter with reference to subsequent figures.

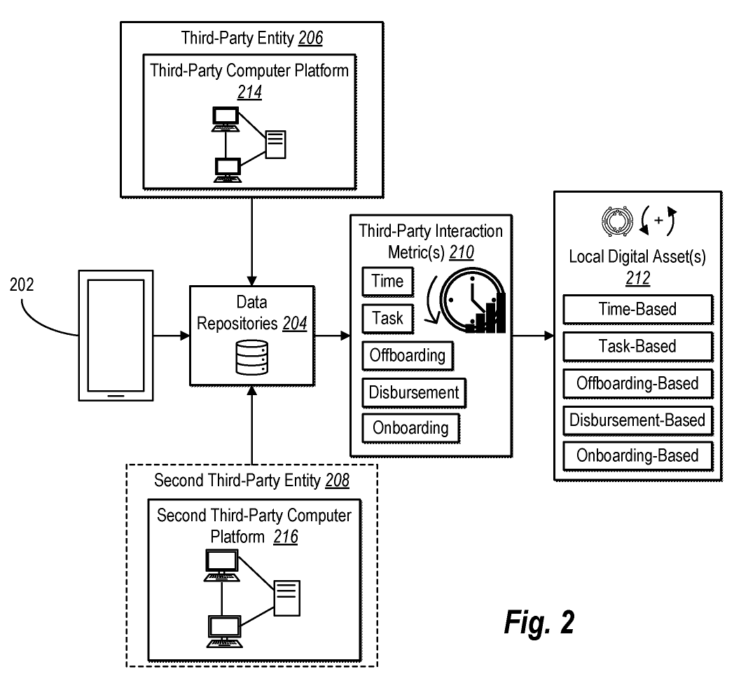

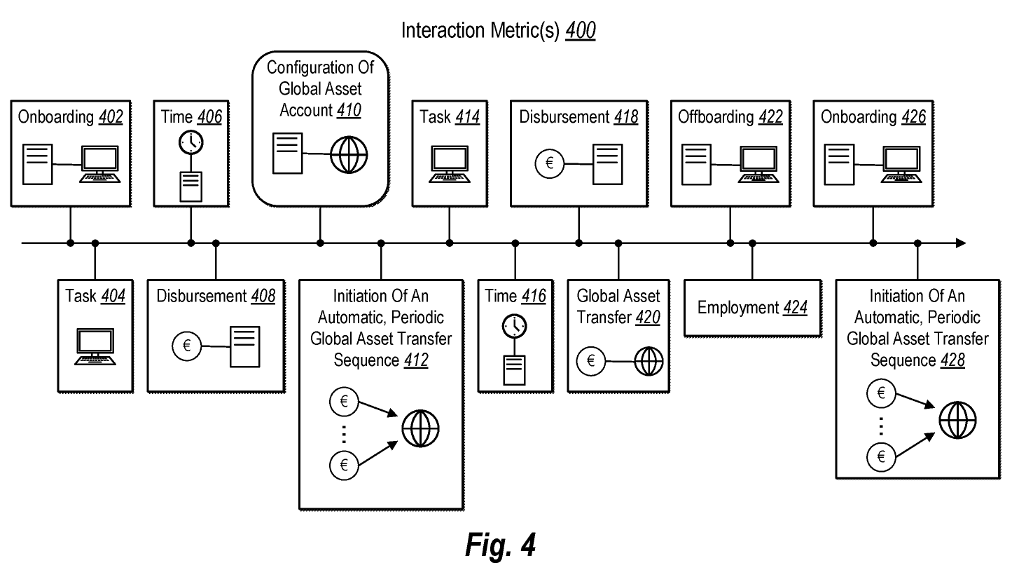

As illustrated in FIG. 1, the cross-platform asset generation system 100 monitors a third-party computer platform 114 to determine third-party interaction metrics 104. In particular, the cross-platform asset generation system 100 utilizes one or more servers to communicate with servers, administrator devices, and/or client devices integrated within the third-party computer platform 114 to monitor the third-party interaction metrics 104 between a client (or a user) corresponding to a client device 102 and a third-party entity. For example, the third-party interaction metrics include a variety of interaction metrics, including, but not limited to, time interaction metrics and/or task interaction metrics. Additional detail is provided below (e.g., in relation to FIGS. 2 and 4) regarding monitoring interactions across computer platforms to determine these and other third-party interaction metrics.

As also illustrated in FIG. 1, the cross-platform asset generation system 100 generates local digital assets 108. Specifically, based on monitoring the third-party interaction metrics 104, the cross-platform asset generation system 100 can detect an event, user activity, and/or other system-defined trigger as predefined by a particular interaction metric. For example, the cross-platform asset generation system 100 can detect a time duration during which the client performs a task in relation to the third-party entity. Upon detecting the event associated with the particular interaction metric, the cross-platform asset generation system 100 can generate the local digital assets 108 associated with particular third-party interaction metrics. For instance, the local digital assets 108 can include local time-based digital assets associated with the time interaction metrics and local task-based digital assets associated with the task interaction metrics. Additional detail is provided below (e.g., in relation to FIG. 2) regarding these and other local digital assets.

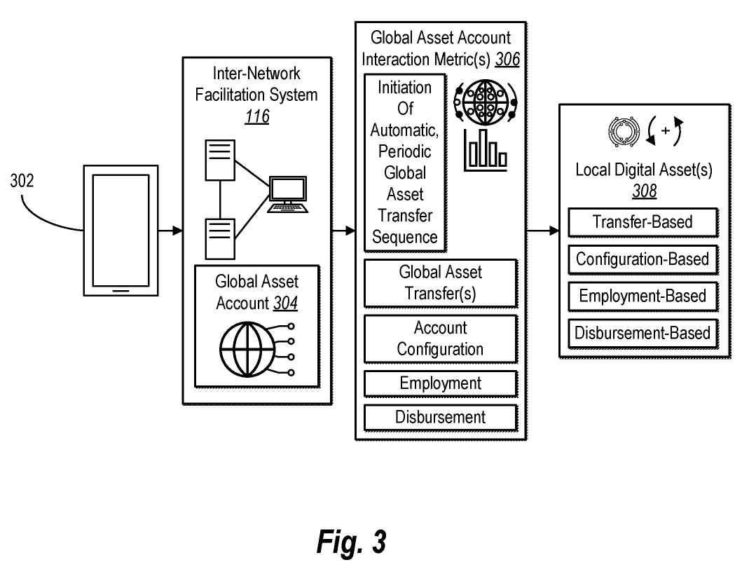

As further illustrated in FIG. 1, the cross-platform asset generation system 100 monitors interactions with an inter-network facilitation system 116 to determine global asset account interaction metrics 106. In particular the cross-platform asset generation system 100 utilizes one or more servers to monitor interactions across servers and administrator devices with the client device 102 to extract the global asset account interaction metrics 106 between the client corresponding to the client device 102 and a global asset account. For example, the global asset account interaction metrics 106 include a variety of interaction metrics, including, but not limited to, initiation of automatic, periodic global asset transfer sequences to a global asset account and/or one or more global asset transfers to a global asset account. Additional detail is provided below (e.g., in relation to FIGS. 3-4) regarding these and other global asset account interaction metrics.

As mentioned above, the cross-platform asset generation system 100 generates the local digital assets 108. Indeed, based on monitoring the global asset account interaction metrics 106, the cross-platform asset generation system 100 can detect an event, user activity, and/or other system-defined trigger as predefined by a particular interaction metric. For example, the cross-platform asset generation system 100 can detect initiation of an automatic, periodic global asset transfer sequence to a global asset account and/or one or more global asset transfers to a global asset account. Upon detecting the event associated with the particular interaction metric, the cross-platform asset generation system 100 can generate the local digital assets 108 associated with particular global asset account interaction metrics. For instance, the local digital assets 108 can further include local transfer-based digital assets associated with the initiation of the automatic, periodic global asset transfer sequences and/or the one or more global asset transfers. Additional detail regarding is provided below (e.g., in relation to FIG. 3) regarding these and other local digital assets.

As shown in FIG. 1, the cross-platform asset generation system 100 generates the local digital assets 108 for a local asset digital account 110 of the client. For instance, in some embodiments, the cross-platform asset generation system 100 generates the local digital assets 108 within the local asset digital account 110. In the same or other embodiments, the cross-platform asset generation system 100 generates the local digital assets 108 in an alternative location and transfers (or duplicates and transfers a copy of) the local digital assets 108 to the local asset digital account 110.

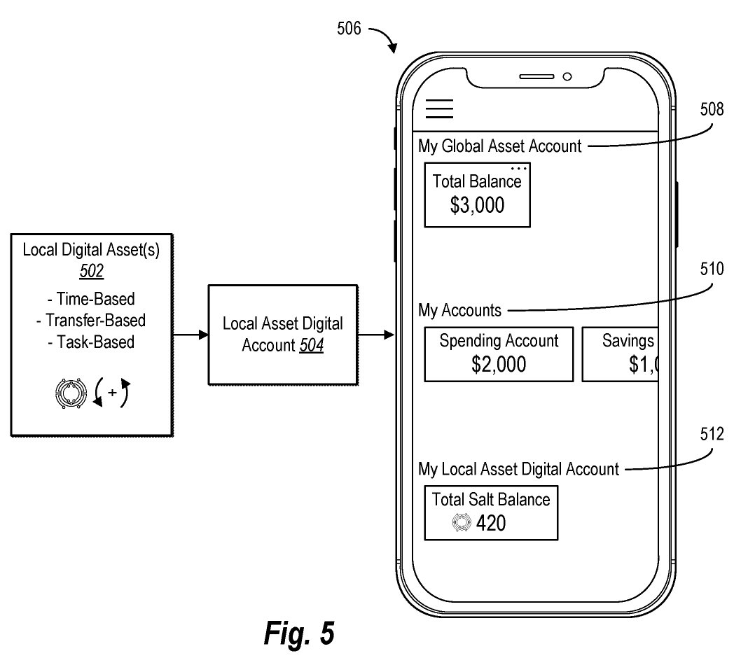

As also shown in FIG. 1, the cross-platform asset generation system 100 performs an act 112 to provide indicators to the client device 102. In particular, the cross-platform asset generation system 100 provides, for display via the client device 102, one or more indicators of the global asset account and one or more indicators of the local asset digital account 110. Specifically, the cross-platform asset generation system 100 can provide the one or more indicators of the global asset account in a graphical user interface (GUI) of the client device 102, such as by displaying one or more accounts assets within the global asset account. Further, the cross-platform asset generation system 100 can provide, in the GUI of the client device 102, the one or more indicators of the local asset digital account 110 reflecting the local digital assets 108. For example, the one or more indicators of the local asset digital account 110 can include one or more indicators for the local time-based digital assets and/or the local transfer-based digital assets. Additional detail regarding graphical user interfaces and indicators generated by the cross-platform asset generation system 100 are provided below (e.g., in relation to FIG. 5).

Recent years have seen significant improvements in the technical environment of intelligent asset generation and management systems. For instance, conventional systems typically monitor and/or identify downstream interactions with client devices that involve the consumption or disbursement of assets associated with a client asset account. As an example, conventional systems can monitor the client asset account to determine when the client consumes or disburses existing (or credited) assets associated with the client asset account. Based on monitoring and identifying these limited downstream interactions, conventional systems can generate a limited number and limited types of digital assets for the client. Some conventional systems may also provide for the client to utilize the digital assets in acquiring a particular redemption benefit. However, despite such capabilities, conventional systems nevertheless exhibit a number of deficiencies or drawbacks, particularly relating to functionality, flexibility, and efficiency.

For instance, conventional systems lack functionality and flexibility. In particular, conventional systems are often limited by the number and type of digital interactions they can monitor and/or identify. As an example, conventional systems typically are confined to monitoring and/or identifying downstream interactions involving the consumption or disbursement of existing (or credited) assets associated with a client asset account. Further, due in part to their limited monitoring and identifying capabilities, conventional systems typically are limited by the number and type of digital assets they can generate and manage. For example, conventional systems are typically configured to generate and manage digital assets for the client based on the identified downstream interactions.

Furthermore, conventional systems are often limited in tracking a particular type of digital asset for a particular operational platform. For example, conventional systems often utilize dedicated applications to monitor and track a particular form of digital asset through a particular entity. However, this not only leads to limited flexibility but significant computational inefficiency. Indeed, to track and manage multiple digital assets, conventional systems often require users to utilize and transfer between multiple different user interfaces and/or applications. This approach requires excessive time, user interactions, and computer resources.

In one or more embodiments, the cross-platform asset generation system 100 provides several technological improvements or advantages relative to existing systems. For instance, the cross-platform asset generation system 100 can improve functionality and flexibility over prior systems. In particular, in contrast to conventional systems, the cross-platform asset generation system 100 can monitor and/or identify a variety of different interactions with client devices and various third-party entities across computer platforms to generate and manage multiple digital assets. For example, the cross-platform asset generation system 100 monitors one or more third-party interaction metrics between a client and a third-party entity to detect the occurrence of an event, user activity, and/or other system-defined trigger as predefined by the one or more third-party interaction metrics. To illustrate, in at least one embodiment, the cross-platform asset generation system 100 monitors one or more: time interaction metrics, task interaction metrics, offboarding interaction metrics, onboarding interaction metrics, and/or disbursement interaction metrics.

Additionally, the cross-platform asset generation system 100 can monitor and/or detect one or more global asset account interaction metrics with an intern-network facilitation system to detect the occurrence of an event, user activity, and/or other system-defined trigger as predefined by the one or more global asset account interaction metrics. For example, the cross-platform asset generation system 100 monitors and/or detects one or more: initiations of automatic, periodic global asset transfer sequences to a global asset account and/or global asset transfers to a global asset account. As another example, the cross-platform asset generation system 100 monitors one or more: account configuration interaction metrics, employment interaction metrics, and/or disbursement interaction metrics.

Further, due in part to its monitoring and detecting capabilities, the cross-platform asset generation system 100 can also functionally and flexibly generate and manage a larger number of digital assets and a more expansive assortment of digital asset types relative to existing systems. In particular, the cross-platform asset generation system 100 can generate one or more local digital assets for a local asset digital account of the client based on monitoring the third-party interaction metrics and/or the global asset account interaction metrics and detecting the occurrence of an event, user activity, and/or other system-defined trigger as predefined by one or more interaction metrics. Indeed, in some embodiments, the cross-platform asset generation system 100 generates, based on monitoring the third-party interaction metrics, one or more of: local time-based digital assets, local task-based digital assets, local offboarding-based digital assets, local onboarding-based digital assets, and/or local disbursement-based digital assets. Additionally, in some instances, the cross-platform asset generation system 100 generates, based on monitoring and/or detecting the global asset account interaction metrics, one or more of: local transfer-based digital assets, local configuration-based digital assets, local employment-based digital assets, and/or local disbursement-based digital assets.

Moreover, upon generating the one or more local digital assets, the cross-platform asset generation system 100 can also improve functionality and efficiency by managing the one or more local digital assets of the local asset digital account, all from a user interface of a client device, such as a mobile device with limited screen real estate. For instance, the cross-platform asset generation system 100 can provide, for display via the client device, one or more indicators of the global asset account and one or more indicators of the local asset digital account. Further, in one or more embodiments, the cross-platform asset generation system 100 provides, in the GUI of the client device, one or more selectable elements for managing the local digital assets. As an example, the cross-platform asset generation system 100 generates and provides, for display in a GUI of the client device, a local digital asset redemption portal that is accessible via one or more servers. In some instances, the local digital asset redemption portal includes one or more selectable elements for redeeming and/or otherwise modifying or managing the one or more local digital assets of the local asset digital account. Thus, in contrast to conventional systems, the cross-platform asset generation system 100 provides an efficient user interface that reflects consolidated information across entities and digital assets that reduces user interactions and applications at the client device. Accordingly, the cross-platform asset generation system 100 can significantly reduce time and computational resources for intelligently monitoring digital assets at mobile devices.

In addition the cross-platform asset generation system 100 can also provide for automatic tracking capabilities (e.g., by utilizing one or more automated tracking systems). For instance, the cross-platform asset generation system 100 can integrate (or link) with one or more third-party entity platforms, such as those associated with global asset transfer logs, digital time logs, and/or digital task logs. By so doing, in some embodiments, the cross-platform asset generation system 100 can further reduce the amount of time and device interactions with user interfaces required to perform various functions relative to conventional systems.

As illustrated by the foregoing discussion, the present disclosure utilizes a variety of terms to describe features and advantages of the video transcript segmentation system. Additional detail is now provided regarding the meaning of such terms. As used herein, the term “global asset account” refers to a computer-implemented account for managing, receiving, storing, accumulating, generating, modifying, and/or transferring a global asset (e.g., an asset usable across entities, such as a global currency). In particular, the global asset account can serve as a central repository for client holdings and transactions, integrating, in some cases, data from multiple sources to provide a unified, real-time view of activity for the global asset. In some embodiments, the global asset account operates through encrypted communication channels and/or secure storage systems, ensuring persistent, authenticated access to financial resources across devices and/or geographic regions. In the same or other embodiments, the global asset account can facilitate seamless cross-platform interoperability and/or can automate the aggregation and reconciliation of asset data utilizing embedded algorithms and/or programmable logic to manage asset disbursements (e.g., asset transfers) and/or asset deposits, among other things. A global asset account can manage a variety of global assets including various fiat currencies (e.g., dollars or euros) or cryptocurrencies.

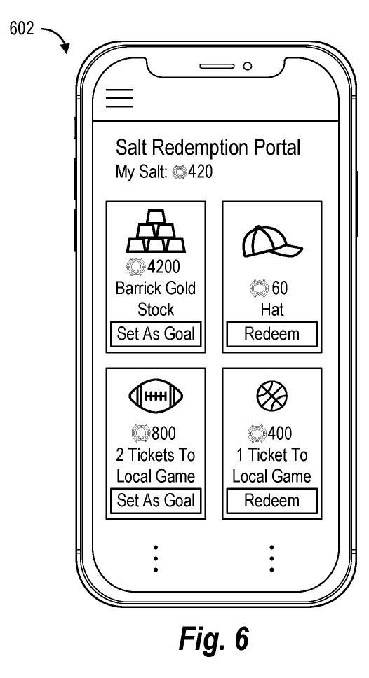

As used herein, the term “local asset digital account” refers to a computer-implemented account for managing, receiving, storing, accumulating, generating, modifying, transferring, or utilizing local digital assets (e.g., assets accepted, redeemable at, or utilized by a local set of entities). For example, a local asset digital account can manage a digital asset utilized at a single entity (e.g., an asset redeemable by a single company) or a group of companies (e.g., a group of ten or twenty affiliated companies). In some embodiments, the local asset digital account is configured to interface with proprietary reward-generation engines, executing algorithmic rulesets to manage and/or allocate digital assets based on one or more predefined metrics. In the same or other embodiments, the local asset digital account includes a local digital asset redemption portal (e.g., as described in greater detail below in relation to FIG. 6).

As also used herein, the term “interaction metric” refers to a data value, point, or parameter that reflects client engagement, activity, and/or behavior within one or more digital platforms or systems. Specifically, interaction metrics can serve as the basis for triggering the generation, allocation, and/or modification of digital assets within a local asset digital account. In one or more embodiments, interaction metrics can include, but are not limited to, third-party interaction metrics and/or global asset account interaction metrics.

As used herein, the term “third-party interaction metric” refers to a data value, point, or parameter representing interactions between a client corresponding to a client device and a third-party platform operated by a third-party entity. In particular, the cross-platform asset generation system 100 monitors third-party interaction metrics by monitoring one or more data repositories that include data associated with interactions between the client and the third-party entity. In some instances, third-party interaction metrics can include, but are not limited to: time interaction metrics, task interaction metrics, offboarding interaction metrics, onboarding interaction metrics, and/or disbursement allocation metrics.

As also used herein, the term “global asset account interaction metric” refers to a data value, point, or parameter representing interactions between a client corresponding to a client device and a global asset account associated with the client. Specifically, the cross-platform asset generation system 100 monitors global asset account interaction metrics by monitoring engagement with and/or activity within a global asset account associated with a client. In some embodiments, global asset account interaction metrics can include, but are not limited to: initiation of automatic, periodic global asset transfer sequences, global asset transfers, account configuration interaction metrics, employment interaction metrics, and/or disbursement interaction metrics. See additional detail below in relation to FIG. 3.

Relatedly, as used herein, the term “local digital asset” refers to an asset that can be accrued, stored, and/or managed within a local asset digital account and that can be utilized by a local set of entities. A local digital asset can be utilized at, redeemed by, transferred to a local set of entities. Thus, for example, a local digital asset can include a reward value redeemable by an entity or across a group of related entities. In particular embodiments, the cross-platform asset generation system 100 can generate local digital assets in response to an event, user activity, and/or other system-defined trigger as predefined by one or more metrics. Based on detecting the particular event, user activity, and/or other system-defined trigger, the cross-platform asset generation system 100 can generate specific types of local digital assets. As an example, the cross-platform asset generation system 100 can generate one or more of the following: local time-based digital assets based on time interaction metrics; task-based local task-based digital assets based on task interaction metrics; local offboarding-based digital assets based on offboarding interaction metrics; local onboarding-based digital assets based on onboarding interaction metrics; local disbursement-based digital assets based on disbursement interaction metrics; local transfer-based digital assets based on detecting initiation of automatic, periodic global asset transfer sequences and/or one or more global asset transfers; local configuration-based digital assets based on account configuration interaction metrics; and/or local employment-based digital assets based on employment interaction metrics. In some cases, the generation and management of local digital assets operate autonomously through embedded algorithms. Further, local digital assets can be redeemed or converted into alternative forms of value from within a local digital asset redemption portal.

As further used herein, the term “automatic, periodic global asset transfer sequence” refers to a computer-executed process that facilitates initiation of recurring, scheduled transfer of assets (e.g., financial assets) from an external source (e.g., a third-party entity) to a designated global asset account. In particular, this sequence may be initiated through the configuration of direct deposit instructions or similar electronic fund transfer authorizations, wherein system-defined parameters can dictate the frequency, timing, and/or volume of each asset transfer event. In some embodiments, the cross-platform asset generation system 100 monitors the digital activity and/or data of the global asset account to detect features of an automatic, periodic global asset transfer sequence (e.g., a first global asset transfer). Along these lines, as used herein, the term “global asset transfer” refers to a computer-executed process that facilitates a transfer of assets (e.g., financial assets) from an external source (e.g., a third-party entity) to a designated global asset account.

Moreover, as used herein, the term “third-party entity” refers to any entity (e.g., organization, business, company, government organization that is separate from an inter-network facilitation system or other system that manages a global asset account). Thus, a third-party entity can include any individual or institution (e.g., an employer) that interacts with a client corresponding to a client device to contribute to the generation, transfer, and/or modification of assets within a global asset account associated with the client. A third-party entity can operate a third-party computer platform that includes servers, client devices, administrative devices, and/or databases (e.g., collectively data repositories) operated or controlled by the third-party entity. A third-party entity can be responsible for initiating an automatic, periodic global asset transfer sequence and/or a global asset transfer, submitting interaction metric data (e.g., third-party interaction metrics), and/or triggering local digital asset generation processes. In some embodiments, a third-party entity interfaces with the cross-platform asset generation system 100 via secure APIs, encrypted data exchanges, and/or proprietary software agents, enabling the system to capture and process transactional and/or engagement data relevant to a global asset account associated with a client and/or a local asset digital account associated with the client.

As mentioned above, the cross-platform asset generation system 100 can generate local digital assets. In particular, the cross-platform asset generation system 100 can generate local digital assets by monitoring third-party interaction metrics. FIG. 2 illustrates an example diagram of generating local digital assets based on monitoring third-party interaction metrics in accordance with one or more embodiments.

As illustrated in FIG. 2, the cross-platform asset generation system 100 monitors one or more data repositories 204 of one or more third-party computer platforms. In particular, the cross-platform asset generation system 100 can monitor the one or more data repositories 204 corresponding to a third-party computer platform 214 to monitor third-party interaction metrics 210 between a client corresponding to a client deice 202 and a third-party entity 206. In additional or alternative embodiments, the cross-platform asset generation system 100 can monitor the one or more data repositories 204 corresponding to a third-party computer platform 216 to monitory the third-party interaction metrics 210 between the client and a second third-party entity 208 (or any number of additional third-party entities).

As used herein, the term “data repository” (e.g., the one or more data repositories 204) refers to a structured, secure digital storage system designed to collect, manage, and/or maintain data volumes, including structured, semi-structured, and/or unstructured information. In particular, a data repository can function as a centralized and/or distributed database that can store data and/or records related to the third-party interaction metrics 210. In one or more embodiments, a data repository is configured to support high-throughput data ingestion, ensuring seamless integration with external systems (e.g., third-party entity systems) through APIs, data pipelines, and/or direct uploads. A data repository can also enable efficient querying, indexing, and/or retrieval of the third-party interaction metrics 210 data, facilitating real-time monitoring and/or analysis. Indeed, in some embodiments, data repository infrastructure allows the cross-platform asset generation system 100 to (e.g., via one or more servers) continuously monitor, analyze, and/or update the third-party interaction metrics 210, ensuring accurate and up-to-date reflections of client activity in relation to a third-party entity (e.g., the third-party entity 206 and/or the second third-party entity 208). A data repository can include storage across a variety of computing devices of the third-party computer platform 214 and/or the third-party computer platform 216 (e.g., servers, administrator devices, dedicated storage devices, etc.).

As also illustrated in FIG. 2, the cross-platform asset generation system 100 monitors the one or more data repositories 204 for a variety of the third-party interaction metrics 210. For instance, the third-party interaction metrics 210 can include, but are not limited to: time interaction metrics, task interaction metrics, offboarding interaction metrics, onboarding interaction metrics, and/or disbursement allocation metrics. In one or more embodiments, the cross-platform asset generation system 100 causes the third-party interaction metrics 210 to be securely stored in the one or more data repositories 204. For instance, the cross-platform asset generation system 100 utilizes one or more automated tracking systems to, upon integrating with one or more platforms associated with the third-party entity 206 (and/or the second third-party entity 208), automatically monitor, store, and/or update the third-party interaction metrics 210 data within the one or more data repositories 204. Further, the cross-platform asset generation system 100 can continuously or periodically analyze the third-party interaction metrics to detect patterns, validate client activity, and/or ensure alignment with predefined engagement thresholds. In the same or other embodiments, the third-party interaction metrics are derived (or collected) from system-monitored data (e.g., through system-monitored data streams), including, but not limited to: timestamp and duration logs, task completion logs, geolocation data, device activity logs, biometric or access control data, workflow and/or project management data, communication records, sensor data, audit trails, and/or via automated tracking systems integrated with third-party platforms or third-party reporting systems.

As just mentioned, the third-party interaction metrics 210 can include the time interaction metrics. Specifically, the time interaction metrics can include data values, points, or parameters that represents or reflects a time duration or a temporal extant during which the client performs a target task, activity, and/or objective in relation to the third-party entity 206 (and/or the second third-party entity 208). For instance, the time interaction metrics can include, but are not limited to, data reflecting: task start and end times, cumulative duration (e.g., in hours), continuous duration (e.g., in hours), segmented durations (e.g., in hours) across multiple sessions, and/or active periods during which the client participates in, completes, and/or fulfills the task, activity, and/or objective. To illustrate, a time interaction metric can include the hours a client works during a particular time frame (e.g., logged hours worked).

As mentioned above, the third-party interaction metrics 210 can include the task interaction metrics. In particular, the task interaction metrics can include data values, points or parameters that can represent or reflect a performance or partial performance of a task, goal, challenge, milestone, activity, and/or objective performed by the client in relation to the third-party entity 206 (and/or the second third-party entity 208). In at least one embodiment, the task interaction metrics captures how, when, and/or where specific client tasks, activities, and/or objectives contribute to the operational objectives of the third-party entity 206 (and/or the second third-party entity 208). For instance, the task interaction metrics captures details such as the type of task, the physical or virtual location where the task is worked upon and/or executed, the status of the task (e.g., indicators reflecting whether the task is in, for example, progress, completed, or pending), task relevance (e.g., a relationship) to broader third-party goals or operational workflows, and/or the conditions under which the task was performed or partially performed. As an example, the cross-platform asset generation system 100 can monitor one or more milestones along the way to a one-year goal and/or keep track of progress made towards reaching the one or more milestones and/or the goal. For instance, a task interaction metric can include a client completing threshold level of interactions with a training software program operated by the third-party entity 206.

As also mentioned above, the third-party interaction metrics 210 can include the offboarding interaction metrics. Specifically, the offboarding interaction metrics can include data values, points or parameters that can represent or reflect the process(es), activity (or activities), and/or conditions associated with departure or termination of a client from the third-party entity 206 (and/or the second third-party entity 208). In at least one embodiment, the offboarding interaction metrics track key events, procedural milestones, and/or compliance-related actions that occur during the offboarding phase. As an example, the offboarding interaction metrics may include, but are not limited to, data reflecting: type of termination (e.g., a classification of offboarding event, such as voluntary, resignation, contract expiration, or involuntary termination), offboarding initiation timestamp, feedback records (e.g., data capturing feedback, interviews, and/or performance reviews collected, including during the exit process), equipment return logs, final tasks completion, access revocation events (e.g., logs indicating when and where the client’s access to systems, platforms, and facilities was disabled), severance and/or benefits details, and/or post-offboarding engagement (e.g., metrics that track remaining interactions between the client and the third-party entity 206 and/or the second third-party entity 208, such as consultations or other contractual obligations). Further, in addition to the methods mentioned above, the offboarding interaction metrics can be derived (or collected) from system-monitored data (e.g., through system-monitored data streams) such as human resource platforms, project management systems, learning management systems (LMSs), and/or security access logs.

As further mentioned above, third-party interaction metrics 210 can include the onboarding interaction metrics. In particular, the onboarding interaction metrics can include data values, points, or parameters that can represent or reflect the process(es), activity (or activities), and/or milestones associated with the initiation, integration, and/or employment of the client by (or with) the third-party entity 206 (and/or the second third-party entity 208). In at least one embodiment, the onboarding interaction metrics track the progression of the client through various stages of the onboarding process, reflecting engagement levels, procedural milestones, and/or compliance-related actions. For instance, the onboarding interaction metrics may include, but are not limited to, data reflecting: an offer acceptance timestamp, documents submission and verification, training and orientation progress and/or completion, system and access provisioning (e.g., records indicting when the client receives access to necessary systems, software platforms, physical facilities, etc.), task assignment and role integration, mentorship or internal networking program assignment and/or participation, and/or onboarding milestone achievements. Further, in addition to the methods mentioned above, the onboarding interaction metrics can be derived (or collected) from system-monitored data (e.g., through system-monitored data streams) such as human resource platforms, project management systems, learning management systems (LMSs), and/or security access logs.

Additionally, as mentioned above, the third-party interaction metrics 210 can include the disbursement interaction metrics. Specifically, the disbursement interaction metrics can include data values, points, or parameters that can represent or reflect the expenditure and/or allocation of client assets (e.g., funds or resources) for employment-related purposes corresponding to the third-party entity 206 (and/or the second third-party entity 208). In some embodiments, the disbursement interaction metrics track and/or reflect the financial-based or resource-based transactions initiated or entered into by (or on behalf of) the client to facilitate job performance, comply with employment requirements, and/or fulfill work-related obligations. For instance, the disbursement interaction metrics may include, but are not limited to, data reflecting: disbursement purpose categorization (e.g., identification of the purpose for which assets are disbursed, such as for fuel, uniforms, tools, equipment, transportation, etc.), disbursement amount (e.g., the value and/or volume of assets expended and/or allocated), frequency of disbursement (e.g., how often disbursement occurs, including recurring disbursements), request status and/or approval/denial of a request status, reimbursements (e.g., reimbursements made by the third-party entity 206 and/or the second third-party entity 208 to the client for assets initially paid for by the client), resource allocation (e.g., a direct provision of physical resources, such as company issued equipment), usage validation and/or verification logs (e.g., to ensure assets were used for their intended purposes), and/or third-party vendor data associated with disbursed resources.

As further illustrated in FIG. 2, the cross-platform asset generation system 100 generates local digital assets 212 for a local asset digital account of the client. In particular, the cross-platform asset generation system 100 can generate the local digital assets 212 for the local asset digital account based on monitoring the third-party interaction metrics 210 included in the one or more data repositories 204. For instance, the cross-platform asset generation system 100 generates the local digital assets 212 in response to detecting the event, user activity, and/or other system-defined trigger as predefined by the third-party interaction metrics 210. Based on detecting the particular event, user activity, and/or other system-defined trigger, the cross-platform asset generation system 100 can generate specific types of the local digital assets 212. For instance, the cross-platform asset generation system 100 can generate one or more of the following: local time-based digital assets based on the time interaction metrics; task-based local task-based digital assets based on the task interaction metrics; local offboarding-based digital assets based on the offboarding interaction metrics; local onboarding-based digital assets based on the onboarding interaction metrics; and/or local disbursement-based digital assets based on the disbursement interaction metrics.

In the same or other embodiments, the cross-platform asset generation system 100 can determine whether to generate the local digital assets 212 for a local asset digital account and/or a value or an amount of local digital assets 212 to generate for the local asset digital account based on various factors. For instance, the cross-platform asset generation system 100 can determine (e.g., based on predefined parameters) whether to generate the local digital assets and/or the value or the amount of local digital assets 212 based on determining a type of account (e.g., a global asset account and/or a local asset digital account) and/or determining a client-entity classification associated with an account and a third-party entity. As an example, the cross-platform asset generation system 100 can determine an employment classification (i.e., that a client is an owner, a partner, an executive employee, an associate employee, a full-time employee, a part-time employee, and/or an independent contractor of a third-party entity) and/or in another client-entity classification with the third-party entity. For example, the cross-platform asset generation system 100 can determine an employment classification based on receiving user-provided information and/or third-party entity input. As another example, the cross-platform asset generation system 100 determines an employment classification based on integrating with an external system (e.g., a third-party entity system, such as an HR third-party system) to pull real-time employment classifications. In the same or other embodiments, the cross-platform asset generation system 100 predicts an employment classification (e.g., via a machine learning model) based on, for example, analyzing work-related metrics and/or patterns in data.

Based on this determination, the cross-platform asset generation system 100 can determine whether to generate local digital assets 212 for the client and/or the value or the amount of the local digital assets 212 to generate for the client. For instance, based on determining that client A is an executive employee and client B is an independent contractor, the cross-platform asset generation system 100 may generate a different (e.g., lower) value or amount of local digital assets 212 for client A than for client B based on monitoring one or more third-party interaction metrics for each client. For example, the cross-platform asset generation system 100 can determine the value or amount of local digital assets 212 to generate for the client based on a predetermined hierarchy for a third-party entity. In the same or other embodiments, the cross-platform asset generation system 100 can make this determination based on an analysis of an anticipated or a predicted behavior modification associated with one or more third-party interaction metrics 210. For instance, the cross-platform asset generation system 100 can predict (e.g., from client data and/or client characteristics, such as employment position) the behavior modification that would result from increasing the value or amount local digital assets 212. As an example, the cross-platform asset generation system 100 can determine that increasing the value or amount of local digital assets 212 for client B may result in a greater behavior modification (such as increased time worked or tasks completed).

As expressed above, in some embodiments, the cross-platform asset generation system 100 generates local digital assets. Specifically, the cross-platform asset generation system 100 can generate local digital assets by monitoring global asset account interaction metrics. FIG. 3 illustrates an example diagram of generating local digital assets based on monitoring global asset account interaction metrics in accordance with one or more embodiments.

As illustrated in FIG. 3, the cross-platform asset generation system 100 monitors a global asset account 304 associated with a client. In particular, the cross-platform asset generation system 100 can monitor the global asset account 304 to monitor global asset account interaction metrics 306 between the client corresponding to a client device 302 and the global asset account 304.

As also illustrated in FIG. 3, the cross-platform asset generation system 100 monitors the global asset account 304 for a variety of the global asset account interaction metrics 306. For example, the global asset account interaction metrics 306 can include, but are not limited to: initiation of automatic, periodic global asset transfer sequences; global asset transfers; account configuration interaction metrics; employment interaction metrics; and/or disbursement interaction metrics. In some embodiments, the cross-platform asset generation system 100 can continuously or periodically analyze the global asset account interaction metrics 306 to detect patterns, validate client activity, and/or ensure alignment with predefined engagement thresholds. In the same or other embodiments, the third-party interaction metrics are derived (or collected) from system-monitored data, including, but not limited to: transaction records, transfer sequences, account configuration data, employment interaction metrics, disbursement logs, authentication and access logs, notification and alert data, third-party integrations, and/or audit trails.

As just mentioned, the global asset account interaction metrics 306 can include the initiation of the automatic, periodic global asset transfer sequences. Specifically, the initiation of the automatic, periodic global asset transfer sequences can include a computer-executed process that facilitates an initiation of recurring, scheduled transfer of assets (e.g., financial assets) from an external source (e.g., a third-party entity) to the global asset account 304. In some embodiments, the cross-platform asset generation system 100 can monitor digital activity and/or data of the global asset account 304 to detect features of an initiation of an automatic, periodic global asset transfer sequence, such as by detecting features of a first global asset transfer from a particular external source. Such features of the automatic, periodic global asset transfer sequence may include, for example, a transfer initiation event (e.g., a trigger that signals the start of the transfer process, such as payroll processing, direct deposit scheduling, and/or a recurring authorization from an external financial institution), a transfer amount (e.g., a specific asset value or asset quantity designated for transfer), a transfer frequency (e.g., an interval at which transfers occur, such as weekly or bi-weekly), source account identification, destination mapping, transfer confirmation data (e.g., data indicating successful or pending transfers received from an external financial system), transfer variability (e.g., detection of changes in transfer patters), transfer authentication and security checks, and/or third-party metadata.

As mentioned above, the global asset account interaction metrics 306 can include the global asset transfers. In particular, the global asset transfers may include a computer-executed process that facilitates an individual, scheduled transfer of assets (e.g., financial assets) from an external source (e.g., a third-party entity) to the global asset account 304. In some embodiments, the cross-platform asset generation system 100 can monitor the digital activity and/or data of the global asset account to detect features of a global asset transfer, including one or more of the features described above in relation to the initiation of the automatic, periodic global asset transfer sequences.

As also mentioned above, the global asset account interaction metrics 306 can include the account configuration interaction metrics. Specifically, the account configuration interaction metrics can include data values, points, or parameters that can represent or reflect the process of establishing, modifying, and/or managing the structural and/or functional parameters of a financial account within a digital platform. In some embodiments, the account configuration interaction metrics can encompass the initialization, downloading, customization, and/or interlinking of accounts to ensure seamless operation and/or integration within a broader financial ecosystem. In the same or other embodiments, the account configuration interaction metrics include, but are not limited to, data reflecting: generating (or creating) a global asset account; generating (or creating) a local asset digital account; associating (or linking and/or integrating) a global asset account with one or more local asset digital accounts (or downloading the one or more local asset digital accounts within the global asset account); configuring authorized users, defining permissions, and/or setting up beneficiaries for transfers and account inheritance; linking (or integrating with) external funding sources or third-party platforms; and/or enabling alerts/notifications, authentication methods (e.g., biometrics, MFA), and/or security protocols (or preferences) governing account activity.

As further mentioned above, the global asset account interaction metrics 306 can include the employment interaction metrics. In particular, the employment interaction metrics can include data values, points, or parameters that can represent or reflect a client’s engagement in activities related to seeking, securing, and/or enhancing employment opportunities with one or more third-party entities. For instance, the employment interaction metrics capture various stages of the employment lifecycle, from job searching and/or skill-building to direct interactions with third-party entities (e.g., employers). In at least one embodiment, the employment interaction metrics include, but are not limited to, data reflecting: employment search activities; interview participation (e.g., with third-party entities or in mock interviews); attending or instructing employment related seminars, career fairs, and/or skill-development workshops; enrolling and/or completing training and/or certification programs; interactions with industry events, mentorship programs, and/or networking sessions; resume creation or updates; and/or third-party entity engagement metrics (e.g., reflecting communication and/or follow-ups between the client and a third-party entity). The cross-platform asset generation system 100 can monitor such employment interaction metrics based on interactions with client devices of the client and/or based on interactions with third-party entities offering the foregoing activities.

Additionally, as mentioned above, the global asset account interaction metrics 306 can include the disbursement interaction metrics. In particular, the disbursement interaction metrics can include data values, points, or parameters that can represent or reflect a disbursement, allocation, withdrawal, or transfer of assets from a global asset account 304 for client-directed expenditures. For instance, the disbursement interaction metrics may track and/or reflect disbursement events regardless of whether the expenditures are employment related. In some embodiments, possible client-directed expenditures may be outlined or provided for in the global asset account 304 GUI, such as with one or more selectable elements. In the context of global asset account interaction metrics 306, the disbursement interaction metrics may include, but are not limited to, data reflecting: a transaction type (e.g., apparel, travel, dining, entertainment, healthcare, etc.), disbursement amount, recipient or vendor data, transaction method (e.g., direct transfers, debit card transactions, credit card transactions, etc.), and/or geolocation and/or timestamp data (e.g., where and when the disbursement occurred).

The global asset account interaction metrics 306 can also include a variety of other metrics. For example, the global asset account interaction metrics 306 can include initiating a loan, transferring assets to pay a loan, achieving a particular credit score, making a remote check deposit, or transferring assets to repay a debit advance. Similarly, the cross-platform asset generation system 100 can determine global asset account interaction metrics 306 based on transfers to satisfy a dynamic base limit value, as described in GENERATING USER INTERFACES COMPRISING DYNAMIC BASE LIMIT VALUE USER INTERFACE ELEMENTS DETERMINED FROM A BASE LIMIT VALUE MODEL, US Application No. 17/519,129, filed November 4, 2021; transmitting increases in base limit values as described by DETERMINING BASE LIMIT VALUES FOR CONTACTS BASED ON INTER-NETWORK USER INTERACTIONS, US Application No., 17/656,816, filed March 28, 2022; initiating connected accounts (e.g., credit account and corresponding debit account to build credit) as described by GENERATING USER INTERFACES COMPRISING A UNIVERSAL DYNAMIC BASE LIMIT VALUE REFLECTING TRANSACTIONS WITHIN ONE OR MORE TRANSACTION ACCOUNTS, US Application No. 18/515,767, filed November 21, 2023; or utilizing dynamic available deposit transaction values, as described by GENERATING GRAPHICAL USER INTERFACES COMPRISING DYNAMIC AVAILABLE DEPOSIT TRANSACTION VALUES DETERMINED FROM A DEPOSIT TRANSACTION PREDICTOR MODEL, US Application No. 18/153,814, filed January 12, 2023. The foregoing patent applications are incorporated herein by reference in their entirety.

As further illustrated in FIG. 3, the cross-platform asset generation system 100 generates local digital assets 308 for a local asset digital account of the client. In particular, the cross-platform asset generation system 100 can generate the local digital assets 308 for the local asset digital account based on monitoring the global asset account interaction metrics 306. For instance, the cross-platform asset generation system 100 generates the local digital assets 308 in response to the event, user activity, and/or other system-defined trigger as predefined by the global asset account interaction metrics 306. Based on detecting the particular event, user activity, and/or other system-defined trigger, the cross-platform asset generation system 100 can generate specific types of the local digital assets 308. For instance, the cross-platform asset generation system 100 can generate one or more of the following: local transfer-based digital assets based on detecting the initiation of the automatic, periodic global asset transfer sequences and/or the global asset transfers; local configuration-based digital assets based on the account configuration interaction metrics; local employment-based digital assets based on the employment interaction metrics, and/or local disbursement-based digital assets based on the disbursement interaction metrics.

The cross-platform asset generation system 100 can generate different quantities of a local digital asset based on different metrics as well. For example, the cross-platform asset generation system 100 can perform a weighted combination of different third-party interaction metrics and/or global asset account interaction metrics to determine a local digital asset. For instance, in some implementations the cross-platform asset generation system 100 normalizes metrics and applies a first weight (e.g., 0.4) to third-party interaction metrics and a second weight (e.g., 0.6) global asset account interaction metrics. In some implementations, the cross-platform asset generation system 100 applies different weights to different types of third-party interaction metrics (e.g., a first weight for a time-based metric and a second weight for another type of third-party interaction metric). Similarly, the cross-platform generation system can apply different weights to different types of global asset account interaction metrics (e.g., a first weight for initiating an account and a second weight for a different type). The value of local digital assets can differ based on type, weight, or combination of these metrics.

In some implementations, the cross-platform asset generation system 100 generates local digital assets in response to combination of both third-party interaction metrics and global asset account interaction metrics. For example, the cross-platform asset generation system 100 can create a sequence of different metrics (from third-party interaction metrics and global asset account interaction metrics) and generate a local digital asset (e.g., a bonus digital asset) for accomplishing the sequence of metrics. To illustrate, upon detecting an automatic, periodic global asset transfer sequences and a time-based interaction metric, the cross-platform asset generation system 100 can generate a local digital asset for the local asset account.

In the same or other embodiments, the cross-platform asset generation system 100 can determine whether to generate the local digital assets 308 for a local asset digital account and/or a value or an amount of local digital assets 308 to generate for the local asset digital account. For instance, the cross-platform asset generation system 100 can determine (e.g., based on predefined parameters) whether to generate the local digital assets and/or the value or the amount of local digital assets 308 based on various factors, such as those detailed above in relation to FIG. 2.

As expressed above, the cross-platform asset generation system 100 monitors one or more interaction metrics. Specifically, the cross-platform asset generation system 100 generates local digital assets based on monitoring one or more third-party interaction metrics and/or one or more global asset account interaction metrics. FIG. 4 illustrates an example timeline of various interaction metrics in accordance with one or more embodiments.

As illustrated in FIG. 4, the cross-platform asset generation system 100 monitors and/or detects interaction metrics 400. In particular, the interaction metrics 400 include one or more third-party interaction metrics and/or one or more global asset account interaction metrics. Although a timeline shown in FIG. 4 shows specific interaction metrics occurring in a specific order, this is not to be understood as the only possible timeline of interaction metrics that the cross-platform asset generation system 100 can monitor and/or detect. Instead, the interaction metrics 400 can include any type of interaction metric and/or any number of each type of interaction metric. Further, the cross-platform asset generation system 100 can monitor the interaction metrics 400 in any possible order.

As also shown in FIG. 4, the cross-platform asset generation system 100 monitors various metrics of the interaction metrics 400 prior to a configuration of a global asset account 410 associated with a client. Specifically, the cross-platform asset generation system 100 can monitor one or more third-party interaction metrics prior to the configuration of the global asset account 410. For instance, prior to the configuration of the global asset account 410, the cross-platform asset generation system 100 can monitor onboarding interaction metric 402, task interaction metric 404, time interaction metric 406, and/or disbursement interaction metric 408. In some embodiments, the cross-platform asset generation system 100 monitors one or more additional, fewer, or alternative third-party interaction metrics prior to the configuration of the global asset account 410.

In one or more embodiments, prior to the configuration of the global asset account 410, the cross-platform asset generation system 100 generates one or more local digital assets for one or more previously configured local asset digital accounts based on monitoring the third-party interaction metrics. For instance, the cross-platform asset generation system 100 can, prior to the configuration of the global asset account 410, generate local onboarding-based digital assets based on monitoring the onboarding interaction metric 402, local task-based digital assets based on monitoring the task interaction metric 404, local time-based digital assets based on monitoring the time interaction metric 406, and/or local disbursement-based digital assets based on monitoring the disbursement interaction metric 408. In some embodiments, the cross-platform asset generation system 100 generates one or more additional, fewer, or alternative local digital assets prior to the configuration of the global asset account 410 based on monitoring one or more additional or alternative third-party interaction metrics.

As further shown in FIG. 4, the cross-platform asset generation system 100 can monitor third-party interaction metrics following the configuration of the global asset account 410. For instance, as shown in FIG. 4, the cross-platform asset generation system 100 monitors, following the configuration of the global asset account 410, task interaction metric 414, time interaction metric 416, offboarding interaction metric 422, and/or onboarding interaction metric 426. In the same or other embodiments, the cross-platform asset generation system 100 may monitor one or more additional, fewer, or alternative third-party interaction metrics following the configuration of the global asset account 410 cross-platform asset generation system.

In at least one embodiment, following the configuration of the global asset account 410, the cross-platform asset generation system 100 may generate one or more local digital assets for the one or more local asset digital accounts based on monitoring the third-party interaction metrics. For instance, following the configuration of the global asset account 410, the cross-platform asset generation system 100 generates local task-based digital assets based on monitoring the task interaction metric 414, local time-based digital assets based on monitoring the time interaction metric 416, local offboarding-based digital assets based on monitoring the offboarding interaction metric 422, and/or local onboarding-based digital assets based on monitoring the onboarding interaction metric 426. In some embodiments, the cross-platform asset generation system 100 generates one or more additional, fewer, or alternative local digital assets following the configuration of the global asset account 410 based on monitoring one or more additional or alternative third-party interaction metrics.

Additionally, as shown in FIG. 4, the cross-platform asset generation system 100 monitors and/or detects one or more global asset account interaction metrics. For instance, the cross-platform asset generation system 100 monitors and/or detects an account configuration interaction metric (e.g., the configuration of the global asset account 410), initiation of an automatic, periodic global asset transfer sequence 412, disbursement interaction metric 418, global asset transfer 420, employment interaction metric 424, and/or initiation of an automatic, periodic global asset transfer sequence 428. In the same or other embodiments, the cross-platform asset generation system 100 may monitor and/or detect one or more additional, fewer, or alternative global asset account interaction metrics.

In at least one embodiment, the cross-platform asset generation system 100 may generate one or more local digital assets for the one or more local asset digital accounts based on monitoring and/or detecting the global asset account interaction metrics. For instance, the cross-platform asset generation system 100 generates: local configuration-based digital assets based on monitoring an account configuration interaction metric (e.g., the configuration of the global asset account 410); local transfer-based digital assets based on monitoring the initiation of the automatic, periodic global asset transfer sequence 412, the initiation of the automatic, periodic global asset transfer sequence 428, and/or the global asset transfer 420; local disbursement-based digital assets based on monitoring the disbursement interaction metric 418; and/or local employment-based digital assets based on monitoring the employment interaction metric 424. In some embodiments, the cross-platform asset generation system 100 generates one or more additional, fewer, or alternative local digital assets based on monitoring and/or detecting one or more additional or alternative global asset account interaction metrics.

Thus, as illustrated in FIG. 4, the cross-platform asset generation system 100 can monitor client interactions with a third-party entity to generate local digital assets. Based on the local digital assets, a client device can initiate an account and corresponding automatic, periodic global asset transfer sequences to generate additional local digital assets. Moreover, after the client relationship with the third-party entity ends, the cross-platform asset generation system 100 can continue managing the global asset digital account and local asset digital account. In addition, upon the client joining an additional third-party entity, the cross-platform asset generation system 100 can then continue generating additional local digital assets based on interactions with the additional third-party computer platform. The cross-platform asset generation system 100 can continue with a variety of additional third-party entities and interactions.

As expressed above, the cross-platform asset generation system 100 can provide indicators to a client device. Specifically, upon generating one or more local digital assets for a local asset digital account, the cross-platform asset generation system 100 can provide one or more indicators of a global asset account and one or more indicators of a local asset digital account to be displayed on a client device. FIG. 5 illustrates an example diagram of providing, for display via a client device, an indicator of a global asset account and an indicator of a local asset digital account reflecting a local time-based digital asset and a local transfer-based digital asset in accordance with one or more embodiments.

As illustrated in FIG. 5, the cross-platform asset generation system 100 can generate local digital assets 502 for a local asset digital account 504. In particular, the cross-platform asset generation system 100 can generate the local digital assets 502 based on monitoring one or more interaction metrics, which can include one or more third-party interaction metrics and/or one or more global asset account interaction metrics, as described in greater detail above. For instance, the cross-platform asset generation system 100 can generate local time-based digital assets, local transfer-based digital assets, and/or local task-based digital assets for the local asset digital account 504, as also described in greater detail above.

In one or more embodiments, upon generating the local digital assets 502, the cross-platform asset generation system 100 transfers the local digital assets 502, or duplicates the local digital assets 502 and transfers a copy of each duplicate, to the local asset digital account 504. Additionally or alternatively, the cross-platform asset generation system 100 can directly generate the local digital assets 502 within the local asset digital account 504.

As also shown in FIG. 5, the cross-platform asset generation system 100 provides, for display in a GUI 506 of a client device, one or more indicators of a global asset account and one or more indicators of the local asset digital account 504. For instance, the cross-platform asset generation system 100 provides an indicator 508 of the global asset account. In some instances, the indicator 508 may reflect a balance, such as a total balance (e.g., of $3,000), of the global asset account. Further, the cross-platform asset generation system 100 may provide for one or more selectable elements to view, access, manage, and/or modify the global asset account. In some embodiments, the cross-platform asset generation system 100 may provide one or more indicators 510 reflecting various accounts included in the global asset account. As an example, the cross-platform asset generation system 100 may provide one or more indicators of a spending (or checking) account, a savings account, a credit account, and/or any other type of account. Moreover, the cross-platform asset generation system 100 may provide for one or more selectable elements to view, access, manage, and/or modify one or more of the various accounts included in the global asset account.

As mentioned above, the cross-platform asset generation system 100 can provide, for display in the GUI 506, one or more indicators of the local asset digital account 504. For example, the cross-platform asset generation system 100 provides an indicator 512 of the local asset digital account 504. In some instances, the indicator 512 may reflect a balance, such as a total local digital asset (e.g., Salt) balance (e.g., of 420 Salt), of the local asset digital account 504. Further, the cross-platform asset generation system 100 may provide for one or more selectable elements to view, access, manage, and/or modify the local asset digital account 504. In some embodiments, the cross-platform asset generation system 100 may provide for one or more selectable elements to view, access, manage, modify, and/or redeem one or more of the various types of local digital assets included in the local asset digital account. Further, in the same or other embodiments, the cross-platform asset generation system 100 can provide at least one visual indicator detailing how local digital assets were earned. For example, upon selection of an indicator of the local digital asset account, the cross-platform asset generation system 100 can display how local digital assets were earned on a transactions interface that lists various pending and/or completed transactions (e.g., incoming or used local digital assets). Such a transaction interface can include the types of local digital assets such as time-based, transfer-based, local task-based, etc.

As expressed above, the cross-platform asset generation system 100 provides, for display in a GUI of a client device, a local digital asset redemption portal that is accessible via one or more servers. In some instances, the local digital asset redemption portal includes one or more selectable elements for redeeming and/or otherwise modifying or managing the one or more local digital assets of the local asset digital account. FIG. 6 illustrates an example graphical user interface that provides a local digital asset redemption portal for redeeming generated local digital assets in accordance with one or more embodiments.

As illustrated in FIG. 6, the cross-platform asset generation system 100 provides, for display in a GUI 602 of a client device, a local digital asset redemption portal (e.g., a Salt redemption portal). As used herein, the term “local digital asset redemption portal” (or “Salt redemption portal”) refers to a digital portal that is accessible via one or more servers and is contained within and/or integrated with the local asset digital account. In particular, the local digital asset redemption portal can enable a client to redeem and/or otherwise modify or manage one or more local digital assets of a local asset digital account. For example, the local digital asset redemption portal can enable a client to redeem local digital assets for, as possible examples, products or goods (e.g., in physical or digital form), merchandise, digital content, services, gift cards, vouchers, travel, hospitality, events, experiences, subscription services, charitable donations, educational courses or certifications, and/or bill payments. As another example, the local digital asset redemption portal can enable the client to obtain exclusive local asset digital account benefits and/or global asset account benefits, and/or to convert local digital assets into one or more alternative forms of value within the ecosystem of the cross-platform asset generation system 100.

To elaborate, as also illustrated in FIG. 6, the cross-platform asset generation system 100 can provide, in the local digital asset account redemption portal (e.g., the Salt redemption portal), various ways or methods to redeem local digital assets (e.g., Salt) of a local asset digital account. In particular, the cross-platform asset generation system 100 may provide, in the local digital asset redemption portal, one or more indicators of the various ways or methods to redeem the local digital assets, such as on Barrick Gold stock, a hat, 2 tickets to a local game, and/or on 1 ticket to a local game. In some embodiments, the cross-platform asset generation system 100 may provide one or more selectable elements to, for example, redeem local digital assets in a particular way or method and/or to set a goal to later redeem local digital assets in a particular way or method.

In the same or other embodiments, the cross-platform asset generation system 100 provides one or more specific local digital asset redemption portals for particular accounts (e.g., global asset account and/or local asset digital account). As an example, the cross-platform asset generation system 100 can provide a specific local digital asset redemption portal for users who have undergone offboarding in relation to a third-party entity (e.g., have been terminated by the third-party entity).

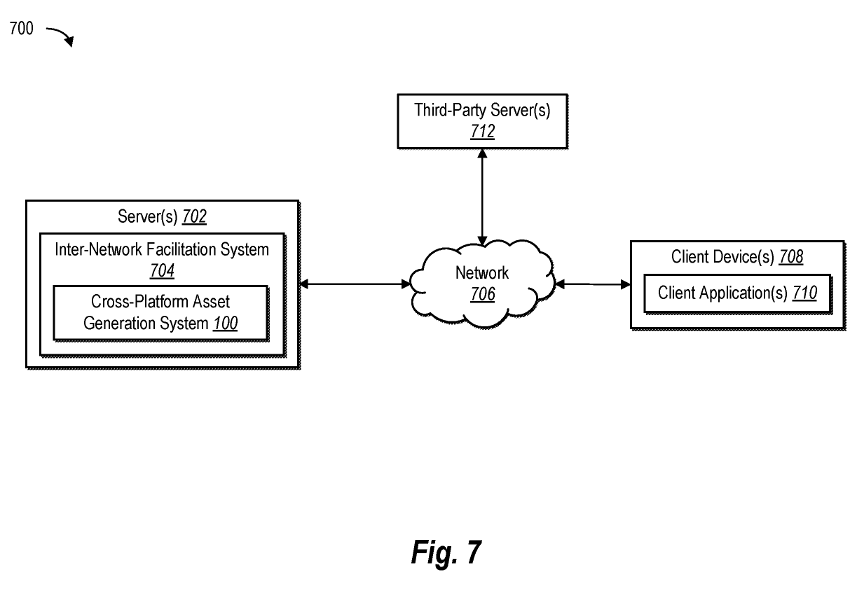

In some embodiments, the cross-platform asset generation system 100 is part of a networking environment. For example, FIG. 7 illustrates a diagram of an example environment in which the cross-platform asset generation system 100 can operate in accordance with one or more embodiments.

As shown in FIG. 7, system 700 includes server(s) 702 (which includes inter-network facilitation system 704 and cross-platform asset generation system 100), client device(s) 708, and third-party server(s) 712. As further illustrated in FIG. 7, the server(s) 702, the client device(s) 708, and the third-party server(s) 712 can communicate via the network 706.

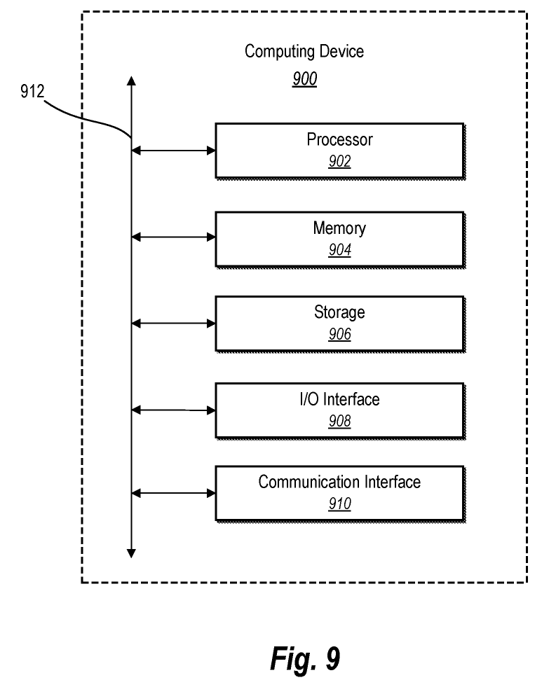

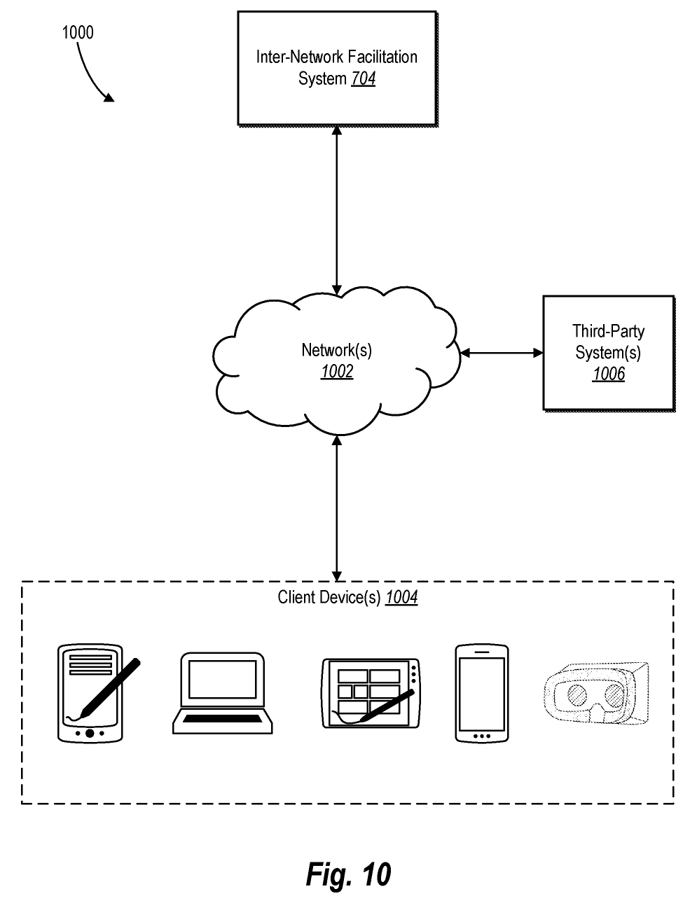

Although FIG. 7 illustrates the cross-platform asset generation system 100 being implemented by a particular component and/or device within system 700, the cross-platform asset generation system 100 can be implemented, in whole or in part, by other computing devices and/or components within the system 700 (e.g., the client device(s) 708). Additional description regarding the illustrated computing devices (e.g., the server(s) 702, computing devices implementing the cross-platform asset generation system 100, the client device(s) 708, and/or the network 706) is provided with respect to FIGS. 9-10 below.

As shown in FIG. 7, the server(s) 702 can include the inter-network facilitation system 704. In some embodiments, the inter-network facilitation system 704 can determine, store, generate, and/or display financial information and/or local digital asset information corresponding to a user (or a client) account (e.g., in a banking application or a money transfer application). Furthermore, the inter-network facilitation system 704 can also electronically communicate (or facilitate) financial transactions between one or more user (or client) accounts (and/or computing devices). Moreover, the inter-network facilitation system 704 can also track and/or monitor financial transactions and/or financial transaction behaviors of a user (or a client) within a user (or a client) account.

The inter-network facilitation system 704 can include a system that comprises the cross-platform asset generation system 100 and that facilitates financial transactions and digital communications across different computing systems over one or more networks. For example, the inter-network facilitation system 704 manages local asset digital accounts and/or global asset accounts (e.g., credit accounts, secured accounts, and/or other accounts) for one or more accounts registered within the inter-network facilitation system 704. In some cases, the inter-network facilitation system 704 is a centralized network system that facilitates access to local asset digital accounts and/or global asset accounts (e.g., online banking accounts, credit accounts, and/or other accounts) within a central network location. Indeed, the inter-network facilitation system 704 can link accounts from different network-based financial institutions to provide information regarding, and management tools for, the different accounts.

As also illustrated in FIG. 7, system 700 includes the client device(s) 708. For example, the client device(s) 708 may include, but are not limited to, mobile devices (e.g., smartphones, tablets) or other types of computing devices, including those explained below with reference to FIGS. 9-10. Additionally, the client device(s) 708 can include computing devices associated with (and/or operated by) user accounts for the inter-network facilitation system 704. Moreover, system 700 can include various numbers of client devices that communicate and/or interact with the inter-network facilitation system 704 and/or the cross-platform asset generation system 100.

Furthermore, as shown in FIG. 7, the client device(s) 708 can include client application(s) 710. Client application(s) 710 can include instructions that (upon execution) cause the client device(s) 708 to perform various actions. For example, a user of a user account can interact with client application(s) 710 on client device(s) 708 to access financial information, access local digital asset information, manage local digital assets, initiate a financial transaction (e.g., transfer money to another account, deposit money, withdraw money), and/or access or provide data (to the server(s) 702). Furthermore, in one or more implementations, the client application(s) 710 can display one or more graphical user interfaces from which the cross-platform asset generation system 100 can receive and display information regarding network transactions.

In certain instances, the client device(s) 708 corresponds to one or more user accounts (e.g., user accounts stored at the server(s) 702). For instance, a user of a client device can establish a user account with login credentials and various information corresponding to the user. In addition, the user accounts can include a variety of information regarding local digital asset information, financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device but any device corresponding to a user account of a particular user. Accordingly, in using the term client device, this disclosure can refer to any computing device corresponding to a user account of the inter-network facilitation system 704.

As illustrated in FIG. 7, system 700 includes third-party server(s) 712. In one or more embodiments, the third-party server(s) 712 facilitates seamless data exchange of data associated with a third-party entity and/or a client (or user) between third-party platform(s) and the inter-network facilitation system 704 and/or the cross-platform asset generation system 100. For instance, the third-party server(s) 712 enables the inter-network facilitation system 704 and/or the cross-platform asset generation system 100 to receive, access, process, and/or store (e.g., in one or more data repositories) data associated with a third-party entity and/or a client from the third-party platform(s). In some instances, the data associated with the third-party entity and/or the client includes data associated with one or more interaction metrics (e.g., third-party interaction metrics). As illustrated, third-party server(s) 712 can be located on a separate server. In some cases, the third-party server(s) 712 can be integrated or included in the cross-platform asset generation system 100 or the inter-network facilitation system 704.

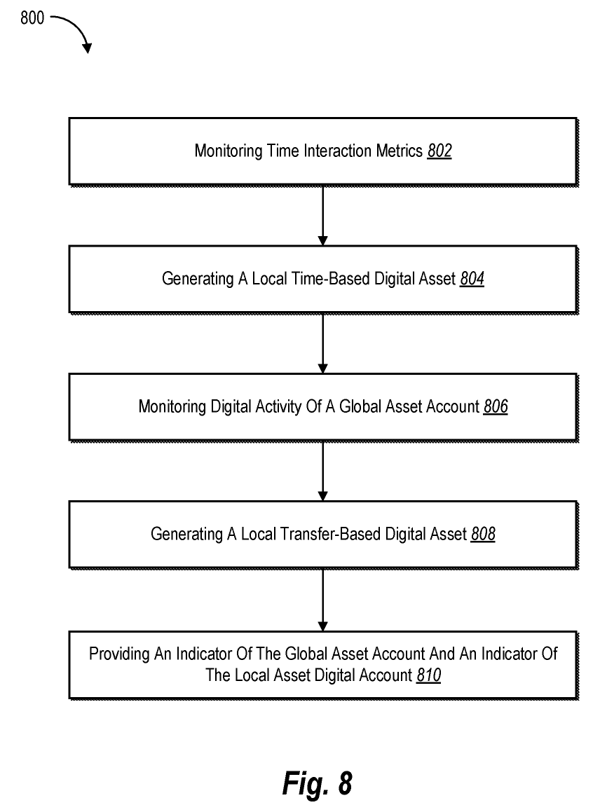

As further shown in FIG. 7, the system 700 includes the network 706. As mentioned above, the network 706 can enable communication between components of the system 700. In one or more embodiments, the network 706 may include a suitable network and may communicate using a various number of communication platforms and technologies suitable for transmitting data and/or communication signals, examples of which are described with reference to FIG. 8. Furthermore, although FIG. 7 illustrates the server(s) 702, the client device(s) 708, and the third-party server(s) 712 communicating via the network 706, the various components of the system 700 can communicate and/or interact via other methods (e.g., the server(s) 702 and the client device(s) 708 can communicate directly).

FIGS. 1-7, the corresponding text, and the examples provide a number of different systems and methods for generating local digital assets. In addition to the foregoing, implementations can also be described in terms of flowcharts comprising acts steps in a method for accomplishing a particular result. For example, FIG. 8 illustrates an example flowchart of a series of acts for generating a transcriptomic benchmark in accordance with one or more embodiments. While FIG. 8 illustrates acts according to certain implementations, alternative implementations may omit, add to, reorder, and/or modify any of the acts shown in FIG. 8. The acts of FIG. 8 can be performed as part of a method. Alternatively, a non-transitory computer readable medium can comprise instructions that, when executed by one or more processors, cause a computing device to perform the acts of FIG. 8. In still further implementations, a system can perform the acts of FIG. 8. Additionally, the acts described herein may be repeated or performed in parallel with one another or in parallel with different instances of the same or other similar acts.

As illustrated in FIG. 8, the series of acts 800 may include an act 802 of monitoring time interaction metrics. In particular, the act 802 involves monitoring, utilizing one or more servers, time interaction metrics between a client corresponding to a client device and a third-party entity. The series of acts 800 can also include an act 804 of generating a local time-based digital asset. In particular, the act 804 can involve generating a local time-based digital asset for a local asset digital account of the client based on the time interaction metrics between the client and the third-party entity. Additionally, the series of acts 800 can include an act 806 of monitoring digital activity of a global asset account. In particular, the act 806 can involve monitoring, utilizing the one or more servers, digital activity of a global asset account to detect initiation of an automatic, periodic global asset transfer sequence to the global asset account. Further, the series of acts 800 can include the act 808 of generating a local transfer-based digital asset. In particular, the act 808 can involve, in response to detecting the initiation of the automatic, periodic global asset transfer sequence, generating a local transfer-based digital asset for the local asset digital account. Moreover, the series of acts 800 can include an act 810 of providing an indicator of the global asset account and an indicator of the local asset digital account. In particular, the act 810 can involve providing, for display via the client device, an indicator of the global asset account and an indicator of the local asset digital account reflecting the local time-based digital asset and the local transfer-based digital asset.

In some embodiments, the series of acts 800 includes an act of monitoring the time interaction metrics by monitoring a data repository comprising a time duration during which the client performs a target task in relation to the third-party entity. The series of acts 800 can also include an act of generating the local time-based digital asset for the local asset digital account by generating a local digital asset redeemable via a local digital asset redemption portal accessible via the one or more servers.

In some embodiments, the series of acts 800 includes an act of monitoring the digital activity of the global asset account to detect features of a first global asset transfer; and detecting the initiation of the automatic, periodic global asset transfer sequence based on the features of the first global asset transfer. In the same or other embodiments, the series of acts 800 includes an act of in response to detecting a first global asset transfer of the automatic, periodic global asset transfer sequence, generating a first local transfer-based digital asset; and, in response to detecting a second global asset transfer of the automatic, periodic global asset transfer sequence, generating a second local transfer-based digital asset.

In one or more embodiments, the series of acts 800 includes an act of providing, for display via the client device, the indicator of the global asset account and the indicator of local asset digital account by providing for display the indicator of the local asset digital account reflecting the local time-based digital asset, the first local transfer-based digital asset, and the second local transfer-based digital asset. The series of acts 800 can also include an act of monitoring, utilizing one or more servers, task interaction metrics between the client corresponding to the client device and the third-party entity; and generating a local task-based digital asset for the local asset digital account of the client based on the task interaction metrics between the client and the third-party entity.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above (e.g., computing device 900, server(s) 702, client device(s)708). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

FIG. 10 illustrates an example network environment 1000 of the inter-network facilitation system 704. The network environment 1000 includes client device(s) 1004 (e.g., client device(s) 708), an inter-network facilitation system 704, and third-party system(s) 1006 connected to each other by network(s) 1002. Although FIG. 10 illustrates a particular arrangement of the client device(s) 1004, the inter-network facilitation system 704, the third-party system(s) 1006, and the network(s) 1002, this disclosure contemplates any suitable arrangement of the client device(s) 1004, the inter-network facilitation system 704, the third-party system(s) 1006, and the network(s) 1002. As an example, and not by way of limitation, two or more of the client device(s) 1004, the inter-network facilitation system 704, and the third-party system(s) 1006 communicate directly, bypassing the network(s) 1002. As another example, two or more of the client device(s) 1004, the inter-network facilitation system 704, and the third-party system(s) 1006 may be physically or logically co-located with each other in whole or in part.

Moreover, although FIG. 10 illustrates a particular number of the client device(s) 1004, the inter-network facilitation system 704, the third-party system(s) 1006, and the network(s) 1002, this disclosure contemplates any suitable number of the client device(s) 1004, inter-network facilitations systems, the third-party system(s) 1006, and the network(s) 1002. As an example, and not by way of limitation, network environment 1000 may include multiple client devices, inter-network facilitation systems, third-party systems, and/or networks.

This disclosure contemplates any suitable network for the network(s) 1002. As an example, and not by way of limitation, one or more portions of the network(s) 1002 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network(s) 1002 may include one or more networks.

Links may connect the client device(s) 1004, inter-network facilitation system 704 (e.g., which hosts the cross-platform asset generation system 100), and the third-party system(s) 1006 to the network(s) 1002 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device(s) 1004 may be an electronic device including hardware, software, or embedded logic components or a combination of two or more such components and capable of carrying out the appropriate functionalities implemented or supported by the client device(s) 1004. As an example, and not by way of limitation, the client device(s) 1004 may include any of the computing devices discussed above in relation to FIG. 9. The client device(s) 1004 may enable a network user at the client device(s) 1004 to access the network(s) 1002. The client device(s) 1004 may enable its user to communicate with other users at other client devices of the client device(s) 1004.

In particular embodiments, the client device(s) 1004 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device(s) 1004 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device(s) 1004 one or more Hyper Text Markup Language (“HTML”) files responsive to the HTTP request. The client device(s) 1004 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 704 may be a network-addressable computing system that can interface between two or more computing networks or servers associated with different entities such as financial institutions (e.g., banks, credit processing systems, ATM systems, or others). In particular, the inter-network facilitation system 704 can send and receive network communications (e.g., via the network(s) 1002) to link the third-party system(s) 1006. For example, the inter-network facilitation system 704 may receive authentication credentials from a user to link the third-party system(s) 1006 such as an online bank account, credit account, debit account, or other financial account to a user account within the inter-network facilitation system 704. The inter-network facilitation system 704 can subsequently communicate with the third-party system(s) 1006 to detect or identify balances, transactions, withdrawal, transfers, deposits, credits, debits, or other transaction types associated with the third-party system(s) 1006. The inter-network facilitation system 704 can further provide the aforementioned or other financial information associated with the third-party system(s) 1006 for display via the client device(s) 1004. In some cases, the inter-network facilitation system 704 links more than one of the third-party system(s) 1006, receiving account information for accounts associated with each respective third-party system of the third-party system(s) 1006 and performing operations or transactions between the different systems via authorized network connections.

In particular embodiments, the inter-network facilitation system 704 may interface between an online banking system and a credit processing system via the network(s) 1002. For example, the inter-network facilitation system 704 can provide access to a bank account of the third-party system(s) 1006 and linked to a user account within the inter-network facilitation system 704. Indeed, the inter-network facilitation system 704 can facilitate access to, and transactions to and from, the bank account of the third-party system(s) 1006 via a client application of the inter-network facilitation system 704 on the client device(s) 1004. The inter-network facilitation system 704 can also communicate with a credit processing system, an ATM system, and/or other financial systems (e.g., via the network(s) 1002) to authorize and process credit charges to a credit account, perform ATM transactions, perform transfers (or other transactions) across accounts of different third-party systems of the third-party system(s) 1006, and to present corresponding information via the client device(s) 1004.

In particular embodiments, the inter-network facilitation system 704 includes a model for approving or denying transactions. For example, the inter-network facilitation system 704 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 704 and/or the third-party system(s) 1006), the inter-network facilitation system 704 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 704 may be accessed by the other components of network environment 1000 either directly or via the network(s) 1002. In particular embodiments, the inter-network facilitation system 704 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 704 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device(s) 1004, or an inter-network facilitation system 704 to manage, retrieve, modify, add, or delete, the information stored in a data store.

In particular embodiments, the inter-network facilitation system 704 may provide users with the ability to take actions on various types of items or objects, supported by the inter-network facilitation system 704. As an example, and not by way of limitation, the items and objects may include financial institution networks for banking, credit processing, or other transactions, to which users of the inter-network facilitation system 704 may belong, computer-based applications that a user may use, transactions, interactions that a user may perform, or other suitable items or objects. A user may interact with anything that is capable of being represented in the inter-network facilitation system 704 or by an external system of a third-party system, which is separate from inter-network facilitation system 704 and coupled to the inter-network facilitation system 704 via the network(s) 1002.

In particular embodiments, the inter-network facilitation system 704 may be capable of linking a variety of entities. As an example, and not by way of limitation, the inter-network facilitation system 704 may enable users to interact with each other or other entities, or to allow users to interact with these entities through an application programming interfaces (“API”) or other communication channels.

In particular embodiments, the inter-network facilitation system 704 may include a variety of servers, sub-systems, programs, modules, logs, and data stores. In particular embodiments, the inter-network facilitation system 704 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 704 may also include suitable components such as network interfaces, security mechanisms, load balancers, failover servers, management-and-network-operations consoles, other suitable components, or any suitable combination thereof. In particular embodiments, the inter-network facilitation system 704 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 704 and the client device(s) 1004. An action logger may be used to receive communications from a web server about a user’s actions on or off the inter-network facilitation system 704. In conjunction with the action log, a third-party-content-object log may be maintained of user exposures to third-party-content objects. A notification controller may provide information regarding content objects to the client device(s) 1004. Information may be pushed to the client device(s) 1004 as notifications, or information may be pulled from the client device(s) 1004 responsive to a request received from the client device(s) 1004. Authorization servers may be used to enforce one or more privacy settings of the users of the inter-network facilitation system 704. A privacy setting of a user determines how particular information associated with a user can be shared. The authorization server may allow users to opt in to or opt out of having their actions logged by the inter-network facilitation system 704 or shared with other systems, such as, for example, by setting appropriate privacy settings. Third-party-content-object stores may be used to store content objects received from third parties. Location stores may be used for storing location information received from the client device(s) 1004 associated with users.

In addition, the third-party system(s) 1006 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 704 via the network(s) 1002. The third-party system(s) 1006 can communicate with the inter-network facilitation system 704 to provide financial information pertaining to balances, transactions, and other information, whereupon the inter-network facilitation system 704 can provide corresponding information for display via the client device(s) 1004. In particular embodiments, the third-party system(s) 1006 communicates with the inter-network facilitation system 704 to update account balances, transaction histories, credit usage, and other internal information of the inter-network facilitation system 704 and/or the third-party system(s) 1006 based on user interaction with the inter-network facilitation system 704 (e.g., via the client device(s) 1004). Indeed, the inter-network facilitation system 704 can synchronize information across one or more of the third-party system(s) 1006 to reflect accurate account information (e.g., balances, transactions, etc.) across one or more networked systems, including instances where a transaction (e.g., a transfer) from one of the third-party system(s) 1006 affects another of the third-party system(s) 1006.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
monitoring, utilizing one or more servers, time interaction metrics between a client corresponding to a client device and a third-party entity;
generating a local time-based digital asset for a local asset digital account of the client based on the time interaction metrics between the client and the third-party entity;
monitoring, utilizing the one or more servers, digital activity of a global asset account to detect initiation of an automatic, periodic global asset transfer sequence to the global asset account;
in response to detecting the initiation of the automatic, periodic global asset transfer sequence, generating a local transfer-based digital asset for the local asset digital account; and
providing, for display via the client device, an indicator of the global asset account and an indicator of the local asset digital account reflecting the local time-based digital asset and the local transfer-based digital asset.

2. The computer-implemented method of claim 1, wherein monitoring the time interaction metrics comprises monitoring a data repository comprising a time duration during which the client performs a target task in relation to the third-party entity.

3. The computer-implemented method of claim 1, wherein generating the local time-based digital asset for the local asset digital account comprises generating a local digital asset redeemable via a local digital asset redemption portal accessible via the one or more servers.

4. The computer-implemented method of claim 1, further comprising:
monitoring the digital activity of the global asset account to detect features of a first global asset transfer; and
detecting the initiation of the automatic, periodic global asset transfer sequence based on the features of the first global asset transfer.

5. The computer-implemented method of claim 1, further comprising:
in response to detecting a first global asset transfer of the automatic, periodic global asset transfer sequence, generating a first local transfer-based digital asset; and
in response to detecting a second global asset transfer of the automatic, periodic global asset transfer sequence, generating a second local transfer-based digital asset.

6. The computer-implemented method of claim 5, wherein providing, for display via the client device, the indicator of the global asset account and the indicator of local asset digital account comprises providing for display the indicator of the local asset digital account reflecting the local time-based digital asset, the first local transfer-based digital asset, and the second local transfer-based digital asset.

7. The computer-implemented method of claim 1, further comprising:
monitoring, utilizing one or more servers, task interaction metrics between the client corresponding to the client device and the third-party entity; and
generating a local task-based digital asset for the local asset digital account of the client based on the task interaction metrics between the client and the third-party entity.

8. A system comprising:
at least one processor; and
at least one non-transitory computer-readable storage medium storing instructions that, when executed by the at least one processor, cause the system to:
monitor, utilizing one or more servers, time interaction metrics between a client corresponding to a client device and a third-party entity;
generate a local time-based digital asset for a local asset digital account of the client based on the time interaction metrics between the client and the third-party entity;
monitor, utilizing the one or more servers, digital activity of a global asset account to detect initiation of an automatic, periodic global asset transfer sequence to the global asset account;
in response to detecting the initiation of the automatic, periodic global asset transfer sequence, generate a local transfer-based digital asset for the local asset digital account; and
provide, for display via the client device, an indicator of the global asset account and the local asset digital account comprising the local time-based digital asset and the local transfer-based digital asset.

9. The system of claim 8, further comprising instructions that, when executed by the at least one processor, cause the system to monitor the time interaction metrics by monitoring a data repository comprising a time duration during which the client performs a target task in relation to the third-party entity.

10. The system of claim 8, further comprising instructions that, when executed by the at least one processor, cause the system to generate the local time-based digital asset for the local asset digital account by generating a local digital asset redeemable via a local digital asset redemption portal accessible via the one or more servers.

11. The system of claim 8, further comprising instructions that, when executed by the at least one processor, cause the system to:
monitor the digital activity of the global asset account to detect features of a first global asset transfer; and
detect the initiation of the automatic, periodic global asset transfer sequence based on the features of the first global asset transfer.

12. The system of claim 8, further comprising instructions that, when executed by the at least one processor, cause the system to:
in response to detecting a first global asset transfer of the automatic, periodic global asset transfer sequence, generate a first local transfer-based digital asset; and
in response to detecting a second global asset transfer of the automatic, periodic global asset transfer sequence, generate a second local transfer-based digital asset.

13. The system of claim 12, further comprising instructions that, when executed by the at least one processor, cause the system to provide, for display via the client device, the indicator of the global asset account and the local asset digital account comprising the local time-based digital asset and the local transfer-based digital asset, wherein the local transfer-based digital asset comprises the first local transfer-based digital asset and the second local transfer-based digital asset.

14. The system of claim 8, further comprising instructions that, when executed by the at least one processor, cause the system to:
monitor, utilizing one or more servers, task interaction metrics between the client corresponding to the client device and the third-party entity; and
generate a local task-based digital asset for the local asset digital account of the client based on the task interaction metrics between the client and the third-party entity.

15. A non-transitory computer-readable medium storing instructions that, when executed by at least one processor, cause a computing device to:
monitor, utilizing one or more servers, time interaction metrics between a client corresponding to a client device and a third-party entity;
generate a local time-based digital asset for a local asset digital account of the client based on the time interaction metrics between the client and the third-party entity;
monitor, utilizing the one or more servers, digital activity of a global asset account to detect initiation of an automatic, periodic global asset transfer sequence to the global asset account;
in response to detecting the initiation of the automatic, periodic global asset transfer sequence, generate a local transfer-based digital asset for the local asset digital account; and
provide, for display via the client device, an indicator of the global asset account and the local asset digital account comprising the local time-based digital asset and the local transfer-based digital asset.

16. The non-transitory computer-readable medium of claim 15, further comprising instructions that, when executed by the at least one processor, cause the computing device to monitor the time interaction metrics by monitoring a data repository comprising a time duration during which the client performs a target task in relation to the third-party entity.

17. The non-transitory computer-readable medium of claim 15, further comprising instructions that, when executed by the at least one processor, cause the computing device to generate the local time-based digital asset for the local asset digital account by generating a local digital asset redeemable via a local digital asset redemption portal accessible via the one or more servers.

18. The non-transitory computer-readable medium of claim 15, further comprising instructions that, when executed by the at least one processor, cause the computing device to:
monitor the digital activity of the global asset account to detect features of a first global asset transfer; and
detect the initiation of the automatic, periodic global asset transfer sequence based on the features of the first global asset transfer.

19. The non-transitory computer-readable medium of claim 15, further comprising instructions that, when executed by the at least one processor, cause the computing device to:
in response to detecting a first global asset transfer of the automatic, periodic global asset transfer sequence, generate a first local transfer-based digital asset; and
in response to detecting a second global asset transfer of the automatic, periodic global asset transfer sequence, generate a second local transfer-based digital asset.

20. The non-transitory computer-readable medium of claim 15, further comprising instructions that, when executed by the at least one processor, cause the computing device to:
monitor, utilizing one or more servers, task interaction metrics between the client corresponding to the client device and the third-party entity; and
generate a local task-based digital asset for the local asset digital account of the client based on the task interaction metrics between the client and the third-party entity.
